(19) United States
(12) Patent Application Publication
(10) Pub. No.: US 2015/0373970 A1
(43) Pub. Date: Dec. 31, 2015

(54) ANTIMICROBIAL COMPOSITIONS, WIPES, AND METHODS

(71) Applicant: 3M INNOVATIVE PROPERTIES COMPANY, St. Paul, MN (US)

(72) Inventors: Myhanh T. Truong, Cottage Grove, MN (US); Matthew T. Scholz, Woodbury, MN (US); Yifan Zhang, Woodbury, MN (US); Narina Y. Stepanova, Inver Grove Heights, MN (US); Cordell M. Hardy, Woodbury, MN (US); Liang Cheng, Shanghai (CN); Lei Zhang, Shanghai (CN)

(21) Appl. No.: 14/765,023

(22) PCT Filed: Feb. 3, 2014
(86) PCT No.: PCT/US2014/014418

§ 371 Date: Jul. 31, 2015

Related U.S. Application Data
(60) Provisional application No. 61/760,420, filed on Feb. 4, 2013.

(51) Int. Cl. A01N 37/14; A01N 25/30; A01N 25/08

(52) U.S. Cl. CPC A01N 37/14; A01N 25/08; A01N 25/30

(57) ABSTRACT

Antimicrobial compositions including an antimicrobial lipid, such as a fatty acid ester, fatty ether, or alkoxide derivative thereof, an enhancer, a surfactant, water, and an optional hydrophilic co-solvent. Such compositions provide effective topical antimicrobial activity and are accordingly useful in cleaning surfaces.

### BACKGROUND

Disinfecting wipes that are pre-loaded with antimicrobial fluids have been used for some time to clean and disinfect household and other nonporous surfaces. Among these fluids, aqueous compositions comprising quaternary ammonium type disinfectants are very common Other compositions have been developed, such as thymol- and citric acid-based compositions. However, there are some drawbacks to using these types of compositions. For example, the safety profile of benzalkonium chloride poses some problems for consumer use, given its tendency to irritate skin and eyes at low aqueous concentration, a correlation in technical literature with asthma symptoms, and the need to rinse food-contact surfaces that have been cleaned with benzalkonium chloride solutions to remove the chemical left behind. Thymol-based compositions may not have a broad enough kill spectrum for some applications. In addition, the relatively high vapor pressure of thymol results in a potentially objectionable odor. Citric acid-based formulations tend to have a low pH (approximately 2.0) for broad antimicrobial efficacy. At such low pH levels the formulation could present some risk of skin irritation as well as damage to susceptible surfaces. A need exists for a consumer-friendly antimicrobial wipe that has a broad kill spectrum, a favorable safety profile, and that does not leave an excessive amount of residue upon drying.

### SUMMARY OF THE DISCLOSURE

The present disclosure provides antimicrobial compositions, wipes, and methods of using and making the compositions and wipes. Such compositions are typically useful when applied to a wide variety of surfaces. They can provide effective reduction, prevention, or elimination of microbes, particularly bacteria, fungi, and viruses. Preferably, the microbes are of a relatively wide variety such that the compositions of the present disclosure have a broad spectrum of activity.

Significantly, certain embodiments of the present disclosure have a very low potential for generating microbial resistance. Thus, such compositions can be applied multiple times over one or more days to eradicate unwanted bacteria.

In one embodiment, the present disclosure provides an antimicrobial composition, as well as a wet wipe that includes such composition, wherein the composition includes: 0.1 wt % to 1.0 wt %, based on the total weight of the composition, of an antimicrobial lipid; 0.1 wt % to 2.0 wt %, based on the total weight of the composition, of an anionic and/or zwitterionic surfactant; 0.03 wt % to 2.0 wt %, based on the total weight of the composition, of an enhancer that includes a soluble organic acid and/or a soluble organic acid salt; and at least 85 wt % water, based on the total weight of the composition.

In such compositions (optionally incorporated into a wet wipe) of the present disclosure, the antimicrobial lipid and the enhancer are present in a ratio of 10:1 to 1:40; and the surfactant and antimicrobial lipid are present in a ratio of greater than 0.5:1.

In such compositions (optionally incorporated into a wet wipe) of the present disclosure, the antimicrobial lipid includes a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, or combinations thereof, wherein the alkoxylated derivative has less than 5 moles of alkoxide per mole of polyhydric alcohol, (C5-C12)1,2-saturated alkanediol, and (C12-C18)1,2-unsaturated alkanediol; with the proviso that for polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof.

In such compositions (optionally incorporated into a wet wipe) of the present disclosure, the pH is 3 to 6, and is no more than 1 unit higher than the pKa of the monofunctional organic acid present with the highest pKa, or no more than 1 unit higher than the highest pKa value less than 5 for polyfunctional organic acids present.

Such compositions of the present disclosure (optionally incorporated into a wet wipe) are in a ready-to-use form that is physically stable; and at least one of the following is true (i.e., possess one or both of the following characteristics): the antimicrobial lipid is liquid when in neat form at 23° C.; or the composition has an optical transmission at 550 nm with a path length of 0.5 cm of at least 80% when measured according to the Light Transmission Test. Certain compositions of the present disclosure possess both of these latter two characteristics.

In certain embodiments, the compositions (optionally incorporated into wet wipes) of the present disclosure display at least 3 to 6 log reduction in test bacteria in 30 seconds with 5% BSA for gram positive and gram negative when evaluated by the Antimicrobial Efficacy Test.

In certain embodiments, the compositions (optionally incorporated into wet wipes) of the present disclosure display bacterial and viral inactivation according to the Disinfectant, Virucidal and Sanitizer Efficacy Test, and antimicrobial kill of both gram positive and gram negative bacteria according to the Antimicrobial Efficacy Test.

The present disclosure also provides methods. In one embodiment, there is a method of killing or inactivating microorganisms, the method includes contacting the microorganisms with the antimicrobial composition as described herein (optionally incorporated in a wet wipe) at a temperature of at least 4° C. for a time effective to kill or inactivate one or more microorganisms.

It should be understood that (unless otherwise specified) the listed concentrations of all components are for “ready-to-use” or “as used” compositions. The compositions can be in a concentrated form. That is, certain embodiments of the compositions can be in the form of concentrates that would be diluted by the user with an appropriate vehicle.

Preferably, the antimicrobial lipid component is present in an amount of at least 0.1 wt %. Unless otherwise specified, all weight percents are based on the total weight of a “ready-to-use” or “as used” composition. Preferably, if the antimicrobial lipid component includes a monoester of a polyhydric alcohol, a monoether of a polyhydric alcohol, or an alkoxylated derivative thereof, then there is no more than 50 wt %, more preferably no more than 40 wt %, even more preferably no more than 25 wt %, and even more preferably no more than 15 wt % of a diester, diether, triester, triether, or alkoxylated derivative thereof present, based on the total weight of the antimicrobial lipid component.

“Effective amount” means the amount of the antimicrobial lipid and/or the enhancer when in a composition, as a whole, provides an antimicrobial (including, for example, antiviral, antibacterial, or antifungal) activity that reduces, prevents, or eliminates one or more species of microbes such that an acceptable level of the microbe results. Typically, this is a level low enough not to cause odor, food poisoning, or other adverse response, and is desirably a non-detectable level. It should be understood that in the compositions of the present disclosure, the concentrations or amounts of the components, when considered separately, may not kill to an acceptable level, or may not kill as broad a spectrum of undesired microorganisms, or may not kill as fast; however, when used together such components provide an enhanced (preferably synergistic) antimicrobial activity (as compared to the same components used alone under the same conditions).

“Hydrophilic” refers to a material that will dissolve or disperse in water (or other aqueous solution as specified) at a temperature of 23° C. in an amount of at least 7% by weight, preferably at least 10% by weight, more preferably at least 20% by weight, even more preferably at least 25% by weight, even more preferably at least 30% by weight, and most preferably at least 40% by weight, based on the total weight of the hydrophilic material and the water. The component is considered dissolved if after thoroughly mixing the compound with water at 60° C. for at least 4 hours and allowing this to cool to 23-25° C. for 24 hours, and mixing the composition thoroughly it appears uniform clear solution without visible cloudiness, phase separation, or precipitate in a jar having a path length of 4 cm. Typically, when placed in 1×1 cm cell, the sample exhibits greater than 70% transmission measured in a suitable spectrophotometer at a wavelength of 655 nm. Water dispersible hydrophilic materials disperse in water to form uniform cloudy dispersions after vigorous shaking of a 5% by weight mixture of the hydrophilic component in water. Preferred hydrophilic components are water-soluble.

“Enhancer” means a component that enhances the effectiveness of the antimicrobial lipid component such that when the composition less the antimicrobial lipid component and the composition less the enhancer component are used separately, they do not provide the same level of antimicrobial activity as the composition as a whole. For example, an enhancer component in the absence of the antimicrobial lipid component may not provide any appreciable antimicrobial activity. The enhancing effect can be with respect to the level of kill, the speed of kill, and/or the spectrum of microorganisms killed, and may not be seen for all microorganisms. In fact, an enhanced level of kill is most often seen in Gram negative bacteria such as Escherichia coli. An enhancer may be a synergist such that when combined with the remainder of the composition, the composition as a whole displays an activity that is greater than the sum of the activity of the composition less the enhancer component and the composition less the antimicrobial lipid component.

“Microorganism” or “microbe” or “microorganism” refers to bacteria, yeast, mold, fungi, protozoa, mycoplasma, as well as viruses (including lipid enveloped RNA and DNA viruses).

“Antimicrobial lipid” means an antiseptic that preferably has a solubility in water of no greater than 1.0 gram per 100 grams (1.0 g/100 g) deionized water. Preferred antimicrobial lipids have a solubility in water of no greater than 0.5 g/100 g deionized water, more preferably, no greater than 0.25 g/100 g deionized water, and even more preferably, no greater than 0.10 g/100 g deionized water. Solubilities are determined using radiolabeled compounds as described under “Conventional Solubility Estimations” in Solubility of Long-Chain Fatty Acids in Phosphate Buffer at pH 7.4, Henrik Vorum et al., in Biochimica et. Biophysica Acta., 1126, 135-142 (1992). Preferred antimicrobial lipids have a solubility in deionized water of at least 100 micrograms (μg) per 100 grams (g) deionized water, more preferably, at least 500 μg/100 g deionized water, and even more preferably, at least 1000 μg/100 g deionized water. The antimicrobial lipids preferably have a hydrophile/lipophile balance (HLB) of at most 6.2, more preferably at most 5.8, and even more preferably at most 5.5. The antimicrobial lipids preferably have an HLB of at least 3, preferably at least 3.2, and even more preferably at least 3.4.

“Fatty” as used herein refers to a straight or branched chain alkyl or alkylene moiety having 6 to 14 (odd or even number) carbon atoms, unless otherwise specified.

The terms “comprises” and variations thereof do not have a limiting meaning where these terms appear in the description and claims.

As used herein, “a,” “an,” “the,” “at least one,” and “one or more” are used interchangeably. The term “and/or” means one or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF ILLUSTRATIVE EMBODIMENTS

The present disclosure provides antimicrobial (including, e.g., antiviral, antibacterial, and antifungal) compositions, wipes, kits, and methods of making and using. These compositions include one or more antimicrobial lipids, such as, for example, a fatty acid ester of a polyhydric alcohol, a fatty ether of a polyhydric alcohol, or alkoxylated derivatives thereof (of either the ester or ether), one or more enhancers, one or more surfactants, water, and one or more optional hydrophilic co-solvents.

Compositions of the present disclosure can be used to provide effective antimicrobial activity to a surface. Compositions and wipes of the present disclosure can be used in methods under conditions effective to kill or inactivate one or more microorganisms, such as bacteria, fungi, and viruses. In certain embodiments, compositions and wipes of the present disclosure display both bacterial and viral inactivation according to the Disinfectant, Virucidal and Sanitizer Efficacy Test (exemplified in the Examples Section), and antimicrobial kill of both gram positive and gram negative bacteria according to the Antimicrobial Efficacy Test (exemplified in the Examples Section).

In certain embodiments, compositions and wipes of the present disclosure demonstrate at least 3 log reduction (and, in certain embodiments, as high as 6 log reduction) in test bacteria in 30 seconds with 5% BSA for both gram positive and gram negative bacteria when evaluated by the Antimicrobial Efficacy Test exemplified in the Examples Section.

Particularly relevant organisms for which a surface can be treated include bacteria such as Staphylococcus spp., Streptococcus spp., Pseudomonas spp., Enterococcus spp., and Esherichia spp., Aspergillus spp., Fusarium spp. Candida spp., food pathogens such as Listeria sp., Listeria monocytogenes, Camphylobacter sp., Clostridium sp., Salmonella sp., as well as combinations thereof. Other relevant organisms include viruses such as herpes virus, rhinovirus, human corona virus, and influenza, Particularly virulent organisms include Staphylococcus aureus (including resistant strains such as Methicillin Resistant Staphylococcus Aureus (MRSA), Staphylococcus epidermidis, Streptococcus pneumoniae, Enterococcus faecalis, Vancomycin Resistant Enterococcus (VRE), Pseudomonas auerginosa, Escherichia coli, Aspergillus niger, Aspergillus fumigatus, Aspergillus clavatus, Fusarium solani, Fusarium oxysporum, Fusarium chlamydosporum, Candida albicans, Candida glabrata, Candida krusei, and combinations thereof. Compositions and wipes of the present disclosure are particularly effective for killing or inactivating bacteria such as Staphylococcus aureus, Salmonella choleraesuis, Salmonella typhinurium, Salmonella enteric, Enterobacter aerogenes, Klebsiella pneumoniae, Escherichia coli, or combinations thereof.

Compositions of the present disclosure can be used on a wide variety of surfaces. For example, they can be used on hard surfaces such as medical (e.g., surgical) devices, floor tiles, countertops, tubs, dishes, as well as on gloves (e.g., kitchen, medical, and surgical gloves). They can also be delivered from swabs, cloth, sponges, foams, nonwovens, and paper products (e.g., paper towels and wipes), for example. Typically, compositions of the present disclosure are delivered from a wipe.

Compositions of the present disclosure, particularly when in a ready-to-use form, are not only effective against a wide variety of microorganisms but are physically stable. As defined herein “physically stable” compositions are those that do not significantly change due to substantial precipitation, crystallization, phase separation, and the like, from their original condition during storage at 23° C. for at least 3 months, and preferably for at least 6 months. Particularly preferred compositions are physically stable if a 10-milliliter (10-ml) sample of the composition when placed in a 15-ml conical-shaped graduated plastic centrifuge tube (Corning) and centrifuged at 3,000 revolutions per minute (rpm) for 10 minutes using a Labofuge B, model 2650 manufactured by Heraeus Sepatech GmbH, Osterode, West Germany (or similar centrifuge at 2275×g) has no visible phase separation in the bottom or top of the tube.

An important characteristic of household wipes that may be used on glossy surfaces and glass is that the dried composition leaves a low haze. Optically clear compositions tend to result in less haze after drying. Furthermore, a clear transparent composition may be preferred by the consumer. In certain embodiments, compositions of the present disclosure have an optical transmission at 550 nm with a path length of 0.5 cm of at least 80% when measured according to the Light TransmissionTest as exemplified in the Examples Section. Preferred compositions have a light transmission of at least 85%, more preferably at least 90%, and most preferably at least 95%.

Gloss measurements can be used as an indication of residue present after treating a surface with the compositions of the present disclosure. In certain embodiments, compositions of the present disclosure exhibit a percent gloss reduction after wiping when compared to a clean test surface of less than 10%, and preferably less than 5%, when tested by the % Gloss Reduction/Haze Test as exemplified in the Examples Section.

Preferred compositions of the present disclosure exhibit good chemical stability. This can be especially a concern with the antimicrobial fatty acid esters, which can often undergo transesterification, for example. In addition, the antimicrobial fatty acid esters can hydrolyze to the fatty acid and the polyhydric alcohol. Preferred compositions retain at least 85%, more preferably at least 90%, even more preferably at least 92%, and even more preferably at least 95%, of the antimicrobial lipid component after aging for 4 weeks at 40° C. (an average of three samples) beyond the initial 5-day equilibration period at 23° C. The most preferred compositions retain an average of at least 97% of the antimicrobial lipid component after aging for 4 weeks at 40° C. in a sealed container beyond the initial 5-day equilibration period at 23° C. The percent retention is understood to mean the weight percent of antimicrobial lipid component retained. This is determined by comparing the amount remaining in a sample aged (i.e., aged beyond the initial 5-day equilibration period) in a sealed container that does not cause degradation, to the actual measured level in an identically prepared sample (preferably from the same batch) and allowed to sit at 23° C. for five days. The level of antimicrobial lipid component is preferably determined using gas chromatography.

### Antimicrobial Lipid

The antimicrobial lipid is that component of the composition that provides at least part of the antimicrobial activity. That is, the antimicrobial lipid has at least some antimicrobial activity for at least one microorganism. It is generally considered the main active component of the compositions of the present disclosure.

In certain embodiments, the antimicrobial lipid includes a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, (C5-C12)1,2-saturated alkanediol, and (C12-C18)1,2-unsaturated alkanediol or combinations thereof.

A fatty acid ester of a polyhydric alcohol is preferably of the formula (R¹—C(O)—O)ₙ—R², wherein R¹ is the residue of a (C8-C12)saturated fatty acid, or a (C12-C22)unsaturated, including polyunsaturated fatty acid, R² is the residue of a polyhydric alcohol (typically and preferably, glycerin, propylene glycol, and sucrose, although a wide variety of others can be used including pentaerythritol, sorbitol, mannitol, xylitol, etc.), and n=1 or 2. The R² group includes at least one free hydroxyl group (preferably, residues of glycerin, propylene glycol, or sucrose). Preferred fatty acid esters of polyhydric alcohols are esters derived from (C8-C12)saturated fatty acids. For embodiments in which the polyhydric alcohol is glycerin or propylene glycol, n=1, although when it is sucrose, n=1 or 2.

Exemplary fatty acid monoesters include, but are not limited to, glycerol monoesters of lauric (monolaurin), caprylic (monocaprylin), and capric (monocaprin) acid, and propylene glycol monoesters of lauric, caprylic, and capric acid, as well as lauric, caprylic, and capric acid monoesters of sucrose. Other fatty acid monoesters include glycerin and propylene glycol monoesters of oleic (18:1), linoleic (18:2), linolenic (18:3), and arachonic (20:4) unsaturated (including polyunsaturated) fatty acids. As is generally known, 18:1, for example, means the compound has 18 carbon atoms and 1 carbon-carbon double bond. Preferred unsaturated chains have at least one unsaturated group in the cis isomer form. In certain preferred embodiments, the fatty acid monoesters that are suitable for use in the present composition include known monoesters of lauric, caprylic, and capric acid, such as that known as GML or the trade designation LAURICIDIN (the glycerol monoester of lauric acid commonly referred to as monolaurin or glycerol monolaurate), glycerol monocaprate, glycerol monocaprylate, propylene glycol monolaurate, propylene glycol monocaprate, propylene glycol monocaprylate, and combinations thereof.

Exemplary fatty acid diesters of sucrose include, but are not limited to, lauric, caprylic, and capric diesters of sucrose as well as combinations thereof.

A fatty ether of a polyhydric alcohol is preferably of the formula (R³—O)ₙ—R⁴, wherein R³ is a (C8-C12) saturated aliphatic group or a (C12-C22) unsaturated, including polyunsaturated, aliphatic group, R⁴ is the residue of glycerin, sucrose, or propylene glycol, and n=1 or 2. For glycerin and propylene glycol n=1, and for sucrose n=1 or 2. Preferred fatty ethers are monoethers of (C8-C12) alkyl groups.

Exemplary fatty monoethers include, but are not limited to, laurylglyceryl ether, caprylglycerylether, caprylylglyceryl ether, laurylpropylene glycol ether, caprylpropyleneglycol ether, and caprylylpropyleneglycol ether. Other fatty monoethers include glycerin and propylene glycol monoethers of oleyl (18:1), linoleyl (18:2), linolenyl (18:3), and arachonyl (20:4) unsaturated and polyunsaturated fatty alcohols. In certain preferred embodiments, the fatty monoethers that are suitable for use in the present composition include laurylglyceryl ether, caprylglycerylether, caprylyl glyceryl ether, laurylpropylene glycol ether, caprylpropyleneglycol ether, caprylylpropyleneglycol ether, and combinations thereof. Unsaturated chains preferably have at least one unsaturated bond in the cis isomer form.

The fatty acid esters or fatty ethers of polyhydric alcohols can be alkoxylated, preferably ethoxylated and/or propoxylated, by conventional techniques. Alkoxylating compounds are preferably selected from the group consisting of ethylene oxide, propylene oxide, and mixtures thereof, and similar oxirane compounds. The alkoxylated derivatives of the aforementioned fatty acid esters and fatty ethers (e.g., one which is ethoxylated and/or propoxylated on the remaining alcohol group(s)) also have antimicrobial activity as long as the total alkoxylate is kept relatively low. That is, the alkoxylated derivative has less than 5 moles of alkoxide per mole of polyhydric alcohol, (C5-C12)1,2-saturated alkanediol, and (C12-C18)1,2-unsaturated alkanediol.

For polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof. That is, in some situations it is desirable to avoid di- or tri-functional esters and ethers as a component of the starting materials.

In certain embodiments, the antimicrobial lipid includes a monoester of a polyhydric alcohol, a monoether of a polyhydric alcohol, or an alkoxylated derivative thereof, or combinations thereof. In certain embodiments, the antimicrobial lipid comprises propylene glycol monolaurate, propylene glycol monocaprate, propylene glycol monocaprylate, or combinations thereof.

In certain embodiments the antimicrobial lipid is a (C5-C12)1,2-saturated alkanediol, and/or (C12-C18)1,2-unsaturated alkanediol. Examples include 1,2 hexane diol, 1,2 octanediol, 1,2 decane diol, 1,2 oleyl diol and mixtures thereof. A particularly preferred material is SYMDIOL 68 which is a mixture of 1,2 hexane diol, 1,2 octanediol available from Symrise Inc., Teterboro, N.J.

In certain embodiments, the desired antimicrobial lipid is liquid when in neat form (i.e., not mixed with a solvent) at room temperature (23° C.).

The compositions of the present disclosure include one or more fatty acid esters, fatty ethers, alkoxylated fatty acid esters, or alkoxylated fatty ethers at a suitable level to produce the desired result.

The compositions of the present disclosure preferably include a total amount of an antimicrobial lipid of at least 0.1 wt %, even more preferably at least 0.25 wt %, even more preferably at least 0.5 wt %, and even more preferably at least 1 wt %, based on the total weight of the composition.

The compositions of the present disclosure preferably include a total amount of an antimicrobial lipid of no greater than 1.0 wt %, based on the total weight of the composition.

In order to reduce the haze left behind by drying the compositions of the present disclosure, in certain embodiments it is preferred that the antimicrobial lipids include an antimicrobial lipid that is a liquid at room temperature. For example, glycerol monolaurate is a relatively crystalline high melting solid and has been found to leave a significant residue but propylene glycol monolaurate and propylene glycol monocaprylate are liquids and leave much less and in some cases almost no haze. Additionally, solid antimicrobial lipids such as glycerol monolaurate can be blended with liquid antimicrobial lipids to produce low haze compositions. Haze can be evaluated with the gloss meter discussed in the examples. In certain embodiments, an important factor appears to be that the neat mixture of the solid and liquid antimicrobial lipid remains liquid at room temperature. Alternatively, the haze of a solid antimicrobial lipid can be reduced by addition of other excipients that will disrupt the crystallinity such that the dry composition remains a liquid and does not form crystals on the wiped surface.

### Enhancer

Compositions of the present disclosure include an enhancer. In certain embodiments, the enhancer (preferably a synergist) functions to enhance the antimicrobial activity especially against Gram negative bacteria, such as E. coli and Psuedomonas sp. The chosen enhancer preferably affects the cell envelope of the bacteria. While not bound by theory, it is presently believed that the enhancer functions by allowing the antimicrobial lipid to more easily enter the cell cytoplasm and/or by facilitating disruption of the cell envelope.

The enhancer includes a soluble organic acid and/or a soluble organic acid salt. In this context, “soluble” refers to soluble in the ready-to-use composition at 23° C. such that an optically clear composition results. That is, such compositions have an optical transmission at 550 nm with a path length of 0.5 cm of at least 80% when measured according to the Light TransmissionTest as exemplified in the Examples Section. Preferred soluble organic acid and/or a soluble organic acid salt provide compositions have a light transmission of at least 85%, more preferably at least 90%, and most preferably at least 95%.

The organic acid may include an alpha-hydroxy acid, a beta-hydroxy acid, other carboxylic acids, a (C1-C4)alkyl carboxylic acid, a (C6-C12)aryl carboxylic acid, a (C6-C12)aralkyl carboxylic acid, a (C6-C12)alkaryl carboxylic acid. Salts of these acids include counterions such as monovalent metals such as sodium, potassium, and lithium; ammonium, monofunctional amines including primary, secondary, tertiary and quaternary amines. Less preferred but useful in some compositions are divalent metals such as calcium and magnesium as well as polyfunctional amines. Various combinations of enhancers can be used if desired.

In certain embodiments, the organic acid is an alpha-hydroxy acid.

In certain embodiments that use a combination of an organic acid and an organic acid salt, the organic acid salt is typically formed by partial neutralization of the organic acid. Alternatively, an organic acid may be mixed with the salt of a different organic acid, for example, as a means of adjusting pH. For example, in certain embodiments that include both an organic acid and an organic acid salt, the salt is not the salt of the organic acid used. For example, one might mix lactic acid and sodium benzoate.

In certain embodiments, at least a first and second acid are used in the compositions of the present disclosure, wherein the first acid is added in its protonated form and the second acid is distinct from the first and is added as its soluble salt.

One or more enhancers may be used in the compositions of the present disclosure at a suitable level to produce the desired result. In certain embodiments, they are present in a total amount of at least 0.03 wt %, based on the total weight of the composition In certain embodiments, they are present in a total amount of no greater than 2.0 wt %, and often in an amount of no greater than 1.5 wt %, based on the total weight of the composition.

In certain embodiments, the total concentration of the enhancer relative to the total concentration of the antimicrobial lipid is in a ratio of 10:1 to 1:40, on a weight basis

In certain embodiments, the pH of compositions of the present disclosure is at least 3.0, preferably at least 3.5, and often at least 4. In certain embodiments, the pH of compositions of the present disclosure is no more than 6, and often no more than 5.

In certain embodiments, the pH of compositions of the present disclosure is no more than 1 unit higher than the pKa of the organic acid present with the highest pKa, wherein the pKa is measured by titration of each individual organic acid in water and is reported by many literature references. For acids with multiple acid groups the desire is to keep at least part of at least one carboxylic acid in the protonated form. Generally, the pKa would be the highest pKa which is less than 5. Thus, the pKa is no more than 1 unit higher than the highest pKa value less than 5 for polyfunctional organic acids present. For example, citric acid has reported pKa values of 3.1, 4.8, and 6.4. Thus, the pH of the composition would be kept at less than 5.8 in order to maintain at least part of acids 2 and 3 in the protonated form.

Alpha-hydroxy Acids. An alpha-hydroxy acid is typically a compound represented by the formula:

R⁵(CR⁶OH)ₙCOOH

wherein: R⁵ and R⁶ are each independently H or a (C1-C8)alkyl group (straight, branched, or cyclic), a (C6-C12)aryl, or a (C6-C12)aralkyl or alkaryl group (wherein the alkyl group is straight, branched, or cyclic), wherein R⁵ and R⁶ may be optionally substituted with one or more carboxylic acid groups; and n=1-3, preferably, n=1-2.

Exemplary alpha-hydroxy acids include, but are not limited to, lactic acid, malic acid, citric acid, 2-hydroxybutanoic acid, 3-hydroxybutanoic acid, mandelic acid, gluconic acid, glycolic acid, tartaric acid, alpha-hydroxyethanoic acid, ascorbic acid, alpha-hydroxyoctanoic acid, hydroxycaprylic acid, and salicylic acid, as well as derivatives thereof (e.g., compounds substituted with hydroxyls, phenyl groups, hydroxyphenyl groups, alkyl groups, halogens, as well as combinations thereof). Preferred alpha-hydroxy acids include lactic acid, malic acid, and mandelic acid. These acids may be in D, L, or DL form and may be present as free acid, lactone, or partial salts thereof. All such forms are encompassed by the term “acid.” Preferably, the acids are present in the free acid form. In certain preferred embodiments, the alpha-hydroxy acids useful in the compositions of the present disclosure are selected from the group consisting of lactic acid, mandelic acid, and malic acid, and mixtures thereof. Other suitable alpha-hydroxy acids are described in U.S. Pat. No. 5,665,776 (Yu).

Beta-hydroxy Acids. A beta-hydroxy acid is typically a compound represented by the formula:

R⁷(CR⁸OH)ₙ(CHR⁹)ₘCOOH or

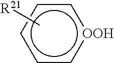

wherein: R⁷, R⁸, and R⁹ are each independently H or a (C1-C8)alkyl group (saturated straight, branched, or cyclic group), a (C6-C12)aryl, or a (C6-C12)aralkyl or alkaryl group (wherein the alkyl group is straight, branched, or cyclic), wherein R⁷ and R⁸ may be optionally substituted with one or more carboxylic acid groups; m=0 or 1; n=1-3 (preferably, n=1-2); and R²¹ is H, (C1-C4)alkyl or a halogen.

Exemplary beta-hydroxy acids include, but are not limited to, salicylic acid, beta-hydroxybutanoic acid, tropic acid, and trethocanic acid. In certain preferred embodiments, the beta-hydroxy acids useful in the compositions of the present disclosure are selected from the group consisting of salicylic acid, beta-hydroxybutanoic acid, and mixtures thereof. Other suitable beta-hydroxy acids are described in U.S. Pat. No. 5,665,776 (Yu).

Other Carboxylic Acids. Carboxylic acids other than alpha- and beta-carboxylic acids are suitable for use in the enhancer component. These include alkyl, aryl, aralkyl, or alkaryl carboxylic acids typically having equal to or less than 12 carbon atoms. A preferred class of these can be represented by the following formula:

R¹⁰(CR¹¹₂)ₙCOOH

wherein: R¹⁰ and R¹¹ are each independently H or a (C1-C4)alkyl group (which can be a straight, branched, or cyclic group), a (C6-C12)aryl group, a (C6-C12) group containing both aryl groups and alkyl groups (which can be a straight, branched, or cyclic group), wherein R¹⁰ and R¹¹ may be optionally substituted with one or more carboxylic acid groups; and n=0-3, preferably, n=0-2. Preferably, the carboxylic acid is a (C1-C4)alkyl carboxylic acid, a (C6-C12)aralkyl carboxylic acid, or a (C6-C12)alkaryl carboxylic acid. Exemplary acids include, but are not limited to, acetic acid, propionic acid, benzoic acid, benzylic acid, nonylbenzoic acid, and the like.

### Surfactant

Compositions of the present disclosure can include one or more surfactants to emulsify the composition and to help wet the surface and/or to aid in contacting the microorganisms. As used herein the term “surfactant” means an amphiphile (a molecule possessing both polar and nonpolar regions which are covalently bound) capable of reducing the surface tension of water and/or the interfacial tension between water and an immiscible liquid. The term is meant to include soaps, detergents, emulsifiers, surface active agents, and the like.

The surfactant is typically an anionic or zwitterionic (i.e., amphoteric) surfactant, or a combination thereof (optionally also including a nonionic surfactant). This includes a wide variety of conventional surfactants; however, certain ethoxylated surfactants can reduce or eliminate the antimicrobial efficacy of the antimicrobial lipid component. The exact mechanism of this inactivation is not known and not all ethoxylated surfactants display this negative effect. For example, poloxamer (polyethylene oxide/polypropylene oxide) surfactants have been shown to be compatible with the antimicrobial lipid component, but ethoxylated sorbitan fatty acid esters such as those sold under the trade name TWEEN by ICI have not been compatible. It should be noted that these are broad generalizations and the activity could be formulation dependent. One skilled in the art can easily determine compatibility of a surfactant by making the formulation and testing for antimicrobial activity as described in the Examples Section. Combinations of various surfactants can be used if desired.

It should be noted that certain antimicrobial lipids are amphiphiles and may be surface active. For example, certain antimicrobial alkyl monoglycerides described herein are surface active. For certain embodiments of the disclosure, the antimicrobial lipid component is considered distinct from a “surfactant” component.

Preferred surfactants are those that have an HLB (i.e., hydrophile to lipophile balance) of at least 4 and more preferably at least 8. Even more preferred surfactants have an HLB of at least 12. Most preferred surfactants have an HLB of at least 15.

Examples of the various classes of surfactants are described below. In certain preferred embodiments, the surfactants useful in the compositions of the present disclosure are selected from the group consisting of sulfonates, sulfates, phosphonates, phosphates, sultaines, and mixtures thereof.

In certain more preferred embodiments, the surfactants useful in the compositions of the present disclosure further include a nonionic surfactant.

One or more surfactants may be used in the compositions of the present disclosure in an effective amount to produce the desired result. In certain embodiments, they are present in a total amount of at least 0.1 wt %, more preferably at least 0.5 wt %, and even more preferably at least 1.0 wt %, based on the total weight of the ready-to-use composition. In certain embodiments, they are present in a total amount of no greater than 2.0 wt %, based on the total weight of the ready-to-use composition.

In certain embodiments, the ratio of the total concentration of surfactant to the total concentration of the antimicrobial lipid is greater than 0.5:1. In certain embodiments, the ratio of the total concentration of surfactant to the total concentration of the antimicrobial lipid is no greater than 4:1 and in certain embodiments, no greater than 2.5:1.

Anionic Surfactants. Exemplary anionic surfactants include, but are not limited to, sarcosinates, glutamates, alkyl sulfates, sodium or potassium alkyleth sulfates, ammonium alkyleth sulfates, ammonium laureth-n-sulfates, laureth-n-sulfates, isethionates, glycerylether sulfonates, sulfosuccinates, alkylglyceryl ether sulfonates, alkyl phosphates, aralkyl phosphates, alkylphosphonates, and aralkylphosphonates. These anionic surfactants may have a metal or organic ammonium counterion. In certain preferred embodiments, the anionic surfactants useful in the compositions of the present disclosure are selected from the group consisting of:

1. Sulfonates and Sulfates.

Suitable anionic surfactants include sulfonates and sulfates such as alkyl sulfates, alkylether sulfates, alkyl sulfonates, alkylether sulfonates, alkylbenzene sulfonates, alkylbenzene ether sulfates, alkylsulfoacetates, secondary alkane sulfonates, secondary alkylsulfates, and the like. Many of these can be represented by the formulas:

R¹⁴—(OCH₂CH₂)ₙ(OCH(CH₃)CH₂)ₚ—(Ph)ₐ-(OCH₂CH₂)ₘ—(O)_{b}—SO₃⁻M⁺

and

R¹⁴—CH[SO₃-M⁺]-R¹⁵

wherein: a and b=0 or 1; n, p, and m=0-100 (preferably 0-20, and more preferably 0-10); R¹⁴ is defined as above provided at least one R¹⁴ or R¹⁵ is at least C8; R¹⁵ is a (C1-C12)alkyl group (saturated straight, branched, or cyclic group) that may be optionally substituted by N, O, or S atoms or hydroxyl, carboxyl, amide, or amine groups; Ph=phenyl; and M is a cationic counterion such as H, Na, K, Li, ammonium, or a protonated tertiary amine such as triethanolamine or a quaternary ammonium group.

In the formula above, the ethylene oxide groups (i.e., the “n” and “m” groups) and propylene oxide groups (i.e., the “p” groups) can occur in reverse order as well as in a random, sequential, or block arrangement. Preferably for this class, R¹⁴ includes an alkylamide group such as R¹⁶—C(O)N(CH₃)CH₂CH₂— as well as ester groups such as —OC(O)—CH₂— wherein R¹⁶ is a (C8-C22)alkyl group (branched, straight, or cyclic group). Examples include, but are not limited to: alkyl ether sulfonates such as lauryl ether sulfates such as POLYSTEP B12 (n=3-4, M=sodium) and B22 (n=12, M=ammonium) available from Stepan Company, Northfield, Ill. and sodium methyl taurate (available under the trade designation NIKKOL CMT30 from Nikko Chemicals Co., Tokyo, Japan); secondary alkane sulfonates such as Hostapur SAS which is a Sodium (C14-C17)secondary alkane sulfonates (alpha-olefin sulfonates) available from Clariant Corp., Charlotte, N.C.; methyl-2-sulfoalkyl esters such as sodium methyl-2-sulfo(C12-16)ester and disodium 2-sulfo(C12-C16) fatty acid available from Stepan Company under the trade designation ALPHASTEP PC-48; alkylsulfoacetates and alkylsulfosuccinates available as sodium laurylsulfoacetate (under the trade designation LANTHANOL LAL) and disodiumlaurethsulfosuccinate (STEPANMILD SL3), both from Stepan Company; alkylsulfates such as ammoniumlauryl sulfate commercially available under the trade designation STEPANOL AM from Stepan Company; dialkylsulfosuccinates such as dioctylsodiumsulfosuccinate available as Aerosol OT from Cytec Industries.

2. Phosphates and Phosphonates.

Suitable anionic surfactants also include phosphates such as alkyl phosphates, alkylether phosphates, aralkylphosphates, and aralkylether phosphates. Many may be represented by the formula:

[R¹⁴—(Ph)ₐ-O(CH₂CH₂O)ₙ(CH₂CH(CH₃)O)ₚ]_{q}—P(O)[O⁻M⁺],

wherein: Ph, R¹⁴, a, n, p, and M are defined above; r is 0-2; and q=1-3; with the proviso that when q=1, r=2, and when q=2, r=1, and when q=3, r=0. As above, the ethylene oxide groups (i.e., the “n” groups) and propylene oxide groups (i.e., the “p” groups) can occur in reverse order as well as in a random, sequential, or block arrangement. Examples include a mixture of mono-, di- and tri-(alkyltetraglycolether)-o-phosphoric acid esters generally referred to as trilaureth-4-phosphate commercially available under the trade designation HOSTAPHAT 340KL from Clariant Corp., as well as PPG-5 ceteth 10 phosphate available under the trade designation CRODAPHOS SG from Croda Inc., Parsipanny, N.J., and mixtures thereof.

Zwitterionic Surfactants. Surfactants of the zwitterionic (i.e., amphoteric) type include surfactants having tertiary amine groups, which may be protonated, as well as quaternary amine containing zwitterionic surfactants. Those that have been particularly useful include:

1. Ammonium Carboxylate Zwitterinics.

This class of surfactants can be represented by the following formula:

R¹⁷—(C(O)—NH)ₐ—R¹⁸—N⁺(R¹⁹)₂—R²⁰—COO⁻

wherein: a=0 or 1; R′⁷ is a (C7-C21)alkyl group (saturated straight, branched, or cyclic group), a (C6-C22)aryl group, or a (C6-C22)aralkyl or alkaryl group (saturated straight, branched, or cyclic alkyl group), wherein R¹⁷ may be optionally substituted with one or more N, O, or S atoms, or one or more hydroxyl, carboxyl, amide, or amine groups; R¹⁹ is H or a (C1-C8)alkyl group (saturated straight, branched, or cyclic group), wherein R¹⁹ may be optionally substituted with one or more N, O, or S atoms, or one or more hydroxyl, carboxyl, amine groups, a (C6-C9)aryl group, or a (C6-C9)aralkyl or alkaryl group; and R¹⁸ and R²⁰ are each independently a (C1-C10)alkylene group that may be the same or different and may be optionally substituted with one or more N, O, or S atoms, or one or more hydroxyl or amine groups.

More preferably, in the formula above, R¹⁷ is a (C1-C18)alkyl group, R¹⁹ is a (C1-C2)alkyl group preferably substituted with a methyl or benzyl group and most preferably with a methyl group. When R¹⁹ is H it is understood that the surfactant at higher pH values could exist as a tertiary amine with a cationic counterion such as Na, K, Li, or a quaternary amine group.

Examples of such zwitterionic surfactants include, but are not limited to: certain betaines such as cocobetaine and cocamidopropyl betaine (commercially available under the trade designations MACKAM CB-35 and MACKAM L from McIntyre Group Ltd., University Park, Ill.); monoacetates such as sodium lauroamphoacetate; diacetates such as disodium lauroamphoacetate; amino- and alkylamino-propionates such as lauraminopropionic acid (commercially available under the trade designations MACKAM 1L, MACKAM 2L, and MACKAM 151L, respectively, from McIntyre Group Ltd.).

2. Ammonium Sulfonate Zwitterionics.

This class of zwitterionic (i.e., amphoteric) surfactants are often referred to as “sultaines” or “sulfobetaines” and can be represented by the following formula

R¹⁷—(C(O)—NH)ₐ—R¹⁸—N⁺(R¹⁹)₂—R₂₀—SO₃⁻

wherein R¹⁷—R²⁰ and “a” are defined above. Examples include cocamidopropylhydroxysultaine (commercially available as MACKAM 50-SB from McIntyre Group Ltd.). The sulfoamphoterics may be preferred over the carboxylate amphoterics since the sulfonate group will remain ionized at much lower pH values.

Optional Nonionic Surfactants. Exemplary nonionic surfactants include, but are not limited to, alkyl glucosides, alkyl polyglucosides, polyhydroxy fatty acid amides, sucrose esters, esters of fatty acids and polyhydric alcohols, fatty acid alkanolamides, ethoxylated fatty acids, ethoxylated aliphatic acids, ethoxylated fatty alcohols (e.g., octyl phenoxy polyethoxyethanol available under the trade name TRITON X-100 and nonyl phenoxy poly(ethyleneoxy) ethanol available under the trade name NONIDET P-40, both from Sigma, St. Louis, Mo.), ethoxylated and/or propoxylated aliphatic alcohols (e.g., that available under the trade name BRIJ from ICI, Wilmington, Del.), ethoxylated glycerides, ethoxylated/propoxylated block copolymers such as PLURONIC and TETRONIC surfactants available from BASF, ethoxylated cyclic ether adducts, ethoxylated amide and imidazoline adducts, ethoxylated amine adducts, ethoxylated mercaptan adducts, ethoxylated condensates with alkyl phenols, ethoxylated nitrogen-based hydrophobes, ethoxylated polyoxypropylenes, polymeric silicones, fluorinated surfactants (e.g., those available under the trade names FLUORAD-FS 300 from 3M Co., St. Paul, Minn., and ZONYL from Dupont de Nemours Co., Wilmington, Del.), and polymerizable (reactive) surfactants (e.g., SAM 211 (alkylene polyalkoxy sulfate) surfactant available under the trade name MAZON from PPG Industries, Inc., Pittsburgh, Pa.). In certain preferred embodiments, the nonionic surfactants useful in the compositions of the present invention are selected from the group consisting of Poloxamers such as PLURONIC from BASF, sorbitan fatty acid esters, and mixtures thereof.

### Hydrophilic Co-Solvent

Compositions of the present disclosure include water. The water is present in an amount of at least 85 wt %, or at least 90 wt %, or at least 95 wt %, based on the total weight of the composition.

Compositions of the present disclosure can include a hydrophilic co-solvent to help solubilize and/or physically stabilize the enhancer component in the composition and/or to enhance the antimicrobial efficacy and/or the speed of antimicrobial efficacy. Incorporation of a sufficient amount of hydrophilic component can increase the antimicrobial activity both in terms of speed of kill and extent of kill. While not intended to be bound by theory, the incorporation of the hydrophilic co-solvent component may act as a humectants and retard drying and thereby give the antimicrobial composition a longer time to kill the microbes during use. Once the composition is completely dry it is believed to have very little antimicrobial activity.

A hydrophilic co-solvent is typically a compound that has a solubility in water of at least 7 wt %, preferably at least 10 wt %, more preferably at least 20 wt %, even more preferably at least 25 wt %, and even more preferably at least 40 wt %, at 23° C. Most preferably, a hydrophilic component is infinitely miscible with water at 23° C.

Exemplary hydrophilic co-solvents include, but are not limited to, a glycol, a lower alcohol, polyether polyols typically having 1-6 alcohol groups and preferably based on ethylene oxide, a short chain alkyl ester, or combinations thereof. In certain embodiments, the optional hydrophilic co-solvent includes: a glycol (i.e., those containing two hydroxyl groups) including glycerol, propylene glycol, dipropylene glycol, tripropylene glycol, polypropylene glycol, polyethylene glycol, diethylene glycol; a C1-C4 lower alcohol, anether such as methoxy terminated polyethylene glycol 350, PEG 400, PEG 1000, glycereth 18, sucrose polyethers and the like, as well as water-soluble ethers such dimethylisosorbideand laureth-4; a short chain alkyl ester (i.e., having a sufficiently small number of carbon atoms to meet the solubility limit above) including triacetin, methyl acetate, methyl lactate, ethyl lactate esters, esters of polyethoxylated glycols; or combinations thereof.

Other than water, one or more hydrophilic co-solvents may be used in the compositions of the present disclosure in an effective amount to produce the desired result. In certain embodiments, a hydrophilic co-solvent is present in an amount of at least 0.1 wt %, based on the total weight of the composition. In certain embodiments, a hydrophilic co-solvent is present in an amount of up to 3 wt %, based on the total weight of the composition.

### Optional Additives

Compositions of the present disclosure may additionally employ adjunct components conventionally found in cleaning wipes (i.e., wet wipes). Thus, for example, the compositions may contain additional dyes, perfumes, lubricants, thickening agents, stabilizers, preservatives, skin emollients and humectants such as those disclosed in U.S. Pat. No. 5,951,993, low levels (e.g., less than 5% wt/wt) solvents to help remove grease and oil such as terpene (e.g., limonene), paraffinic and hydrocarbon solvents, vegetable oils, C2-C4 lower alkyl alcohols, and the like, or combinations thereof.

It may also be suitable to include preservatives in the formulation to aid in preventing the growth of certain organisms. Suitable preservatives include industry standard compounds such as Parabens (methyl, ethyl, propyl, isopropyl, isobutyl, etc), 2 bromo-2-nitro-1,3-diol; 5-bromo-5-nitro-1,3-dioxane, chlorbutanol, diazolidinyl urea; iodopropylnyl butylcarbamate, phenoxyethanol, halogenated cresols, methylchloroisothiazolinons, as well as combinations of these compounds.

It will be appreciated by the skilled artisan that the levels or ranges selected for the required or optional components described herein will depend upon whether one is formulating a composition for direct use, or a concentrate for dilution prior to use, as well as the specific component selected, the ultimate end-use of the composition, and other factors well known to the skilled artisan. For example, a preservative can be present in an amount of up to 1.0 wt %, based on the total weight of the composition.

### Delivery Methods and Wipes

Compositions of the present disclosure can be delivered using a variety of techniques. This can be accomplished by spraying, dipping, wiping, dropping, pouring, toweling, or the like, onto the surface area to be treated.

In certain embodiments, compositions of the present disclosure can be delivered from substrates (e.g., woven or knitted cloth, nonwovens, sponges, foams, paper products such as paper towels, towelettes, laminates of one or more of these substrates and optionally further comprising a film, and wipes) for delivery to a surface. For example, the compositions can be delivered from a wipe or pad which when contacted to a surface will deliver at least a portion of the composition to the surface. The substrate may be used to deliver the composition essentially instantaneously or may be left in contact with the surface.

“Wet” wipe is a wipe where the substrate has been pre-moistened with the antimicrobial composition. In most cases the wipe has been saturated with the composition (i.e., full absorbent capacity of the substrate used). But this may not necessarily have to be the case. It would depend on the absorbent capacity of the wipe and antimicrobial formulation. As long as the wipe can be loaded with enough active material, it wouldn't have to be completely saturated. In some cases the wipes may be super saturated, i.e., have more liquid than its absorbent capacity. This is achieved, for example, by delivering the wipes from a container with excess liquid composition. Wet wipes are typically sold in sealed single-use or resealable multi-use packages or canisters often with an excess of the liquid. “Wet” wipe also includes a wipe that is coated with a concentrate up to 100% solids that is subsequently wet with water by the user. For example, a roll of perforated wipes can be provided in a container to which the user adds a predetermined amount of water that wicks into the roll of wipes.

Nonwoven substrates can be made from synthetic, natural, or chemically modified natural materials, or from mixtures thereof. Suitable synthetic materials include, but are not limited to, synthetic organic polymers such as polyolefins (including polyethylenes (LDPE, LLDPE, metallocene polyethylenes and the like), polypropylene, ethylene/propylene copolymers, polybutylene, ethylene copolymers such as ethylenevinyl acetate and ethylene acrylate copolymers, aliphatic and aromatic polyesters including, but not limited to, PET, PETG, polylactic acid, polyhydroxybutyrate, polyhydroxyvalerate, polyethylenesuccinate, and the like; polyamides, polyurethanes, block copolymers such as Kraton polymers, thermoplastic starches, and copolymers and polymer blends. Non-synthetic materials include natural or chemically modified natural materials. Man-made materials include materials that are manufactured from cellulose, either derivative or regenerated. Typical examples of man-made fibers are regenerated viscose rayon and cellulose acetate. Natural fibers include, but are not limited to, wood pulp, cotton, rayon, bamboo, jute, and hemp. The substrate can be prepared by any method known the art. Suitable manufacturing processes for making a nonwoven substrate that may be used in connection with the present invention include, but are not limited to, carding, meltblown, wet laid, air laid, spunbond, hydroentangling, needlepunching, thermal bonding, etc. and combinations thereof. The fibers used for a nonwoven substrate can include fibers of indefinite length (e.g., filaments), fibers of discrete length (e.g., staple fibers), and multifilament yarns. The fibers used may also be multicomponent fibers including sheath/core, side by side, and splittable fibers. The substrate can be a single layer or multi-layer construction. The nonwoven substrate can also be an abrasive wipe, such as a nonwoven that has a cured resin or binder printed in a pattern on its surface.

In certain embodiments of the present disclosure, a method of killing or inactivating microorganisms is provided. The method includes contacting the microorganisms with an antimicrobial composition as described herein (or a wet wipe that includes such composition) at a temperature of at least 4° C. (preferably, at least 20° C.) (typically, at atmospheric pressure) for a time effective to kill or inactivate one or more microorganisms (preferably, for a time sufficient to achieve the desired level of microorganism reduction).

In certain embodiments of the method of the present disclosure, the microorganisms include bacteria and the antimicrobial composition (or wet wipe incorporating such composition) is used at a temperature of at least 4° C. for a time effective to kill one or more bacteria. In certain embodiments, the bacteria include Staphylococcus spp., Streptococcus spp., Escherichia spp., Enterococcus spp., Pseudamonas spp., or combinations thereof. In certain embodiments, the bacteria include Staphylococcus aureus, Staphylococcus epidermidis, Escherichia coli, Pseudomonas aeruginosa, Streptococcus pyogenes, or combinations thereof.

In certain embodiments of the method of the present disclosure, the microorganisms include one or more viruses and the antimicrobial composition (or wet wipe incorporating such composition) is used under conditions effective to inactivate one or more viruses.

In certain embodiments of the method of the present disclosure, the microorganisms include one or more fungi and the antimicrobial composition (or wet wipe incorporating such composition) is used under conditions effective to kill one or more fungi.

### EXEMPLARY EMBODIMENTS

1. An antimicrobial composition comprising:

0.1 wt % to 1.0 wt %, based on the total weight of the composition, of an antimicrobial lipid;

wherein the antimicrobial lipid comprises a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, or combinations thereof, wherein the alkoxylated derivative has less than 5 moles of alkoxide per mole of polyhydric alcohol, (C5-C12)1,2-saturated alkanediol, and (C12-C18)1,2-unsaturated alkanediol; with the proviso that for polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof;

0.1 wt % to 2.0 wt %, based on the total weight of the composition, of an anionic and/or zwitterionic surfactant;

0.03 wt % to 2.0 wt %, based on the total weight of the composition, of an enhancer comprising a soluble organic acid and/or a soluble organic acid salt; and

at least 85 wt % water, based on the total weight of the composition;

wherein the antimicrobial lipid and the enhancer are present in a ratio of 10:1 to 1:40;

wherein the surfactant and antimicrobial lipid are present in a ratio of greater than 0.5:1;

wherein the pH of the composition is 3 to 6, and is no more than 1 unit higher than the pKa of the monofunctional organic acid present with the highest pKa, or no more than 1 unit higher than the highest pKa value less than 5 for polyfunctional organic acids present;

wherein the composition is in a ready-to-use form that is physically stable; and wherein at least one of the following is true:
the antimicrobial lipid is liquid when in neat form at 23° C.; or
the composition has an optical transmission at 550 nm with a path length of 0.5 cm of at least 80% when measured according to the Light Transmission Test.
   2. The composition of embodiment 1 wherein:

the antimicrobial lipid is liquid when in neat form at 23° C.; and

the composition has an optical transmission at 550 nm with a path length of 0.5 cm of at least 80% when measured according to the Light Transmission Test.

3. The composition of embodiment 1 or 2 which demonstrates antimicrobial activity 3 to 6 log reduction in 30 second antimicrobial efficacy test with 5% BSA for gram positive and gram negative.
4. The composition of any one of embodiments 1 through 3 wherein the enhancer is present in an amount of 0.03 wt % to 1.5 wt %, based on the total weight of the composition.
5. The composition of any one of embodiments 1 through 4 wherein the water is present in an amount of at least 90 wt %, based on the total weight of the composition.
6. The composition of any one of embodiments 1 through 5 wherein the water is present in an amount of at least 95 wt %, based on the total weight of the composition.
7. The composition of any one of embodiments 1 through 6 further comprising a hydrophilic co-solvent.
8. The composition of embodiment 7 wherein the hydrophilic co-solvent comprises a glycol, a C1-C4 lower alcohol, an ether, a short chain alkyl ester, or combinations thereof.
9. The composition of embodiment 7 or 8 wherein the hydrophilic co-solvent is present in an amount of up to 3 wt % based on the total weight of the composition.
10. The composition of any one of embodiments 1 through 9 wherein the antimicrobial lipid comprises a monoester of a polyhydric alcohol, a monoether of a polyhydric alcohol, or an alkoxylated derivative thereof, or combinations thereof.
11. The composition of any one of embodiments 1 through 9 wherein the antimicrobial lipid comprises propylene glycol monolaurate, propylene glycol monocaprate, propylene glycol monocaprylate, or combinations thereof.
12. The composition of any one of embodiments 1 through 11 wherein the soluble organic acid is an alpha-hydroxy acid, a beta-hydroxy acid, a (C1-C4)alkyl carboxylic acid, a (C6-C12)aryl carboxylic acid, a (C6-C12)aralkyl carboxylic acid, a (C6-C12)alkaryl carboxylic acid, or combinations thereof.
13. The composition of embodiment 12 wherein the soluble organic acid is an alpha-hydroxy acid.
14. The composition of any one of embodiments 1 through 13 wherein the composition comprises at least a first and second acid wherein the first acid is added in its protonated form and the second acid is distinct from the first and is added as its soluble salt.
15. The composition of any one of embodiments 1 through 14 wherein the surfactant comprises a sulfonate, a sulfate, a phosphonate, a phosphate, a sultaine, or mixtures thereof.
16. The composition of any one of embodiments 1 through 15 further comprising a nonionic surfactant.
17. The composition of any one of embodiments 1 through 16 which displays at least 3 log reduction in test bacteria in 30 seconds with 5% BSA when evaluated by the Antimicrobial Efficacy Test.
18. The composition of any one of embodiments 1 through 17 which displays bacterial and viral inactivation according to the Disinfectant, Virucidal and Sanitizer Efficacy Test, and antimicrobial kill of both gram positive and gram negative bacteria according to the Antimicrobial Efficacy Test.
19. The composition of any one of embodiments 1 through 18 wherein the pH of the composition is 4 to 6.
20. The composition of embodiment 19 wherein the pH of the composition is 4 to 5.
21. A wet wipe comprising a substrate and a composition impregnated in the substrate, the composition comprising:

0.1 wt % to 1.0 wt %, based on the total weight of the composition, of an antimicrobial lipid;

wherein the antimicrobial lipid comprises a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, or combinations thereof, wherein the alkoxylated derivative has less than 5 moles of alkoxide per mole of polyhydric alcohol, (C5-C12)1,2-saturated alkanediol, and (C12-C18)1,2-unsaturated alkanediol; with the proviso that for polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof;

0.1 wt % to 2.0 wt %, based on the total weight of the composition, of an anionic and/or zwitterionic surfactant;

0.03 wt % to 2.0 wt %, based on the total weight of the composition, of an enhancer comprising a soluble organic acid and a soluble organic acid salt; and

at least 85 wt % water, based on the total weight of the composition;

wherein the antimicrobial lipid and the enhancer are present in a ratio of 10:1 to 1:40;

wherein the surfactant and antimicrobial lipid are present in a ratio of greater than 0.5:1;

wherein the pH of the composition is 3 to 6, and is no more than 1 unit higher than the pKa of the monofunctional organic acid present with the highest pKa, or no more than 1 unit higher than the highest pKa value less than 5 for polyfunctional organic acids present;

wherein the composition is in a ready-to-use form that is physically stable; and wherein at least one of the following is true:
the antimicrobial lipid is liquid when in neat form at 23° C.; or
the composition has an optical transmission at 550 nm with a path length of 0.5 cm of at least 80% when measured according to the Light Transmission Test.
   22. The wet wipe of embodiment 21 wherein:

the antimicrobial lipid is liquid when in neat form at 23° C.; and

the composition has an optical transmission at 550 nm with a path length of 0.5 cm of at least 80% when measured according to the Light Transmission Test.

23. The wet wipe of embodiment 21 or 22 that exhibits a percent gloss reduction after wiping when compared to a clean test surface of less than 10%, when tested by the Gloss Reduction/Haze Test.
24. The wet wipe of any one of embodiments 21 through 23 wherein the composition further comprises a hydrophilic co-solvent.
25. The wet wipe of embodiment 24 wherein the hydrophilic co-solvent comprises a glycol, a C1-C4 lower alcohol, an ether, a short chain alkyl ester, or combinations thereof.
26. The wet wipe of embodiment 25 wherein the hydrophilic co-solvent is present in an amount of up to 10 wt %, based on the total weight of the composition.
27. The wet wipe of any one of embodiments 21 through 26 wherein the composition further comprises a preservative.
28. The wet wipe of embodiment 27 wherein the preservative is present in an amount up to 1.0 wt %, based on the total weight of the composition.
29. The wet wipe of embodiment 28 wherein the liquid antimicrobial lipid comprises a monoester of a polyhydric alcohol, a monoether of a polyhydric alcohol, or an alkoxylated derivative thereof, or combinations thereof.
30. The wet wipe of embodiment 28 wherein the antimicrobial lipid comprises propylene glycol monolaurate, propylene glycol monocaprate, propylene glycol monocaprylate, or combinations thereof.
31. The wet wipe of any one of embodiments 21 through 30 wherein the soluble organic acid is an alpha-hydroxy acid, a beta-hydroxy acid, a (C1-C4)alkyl carboxylic acid, a (C6-C12)aryl carboxylic acid, a (C6-C12)aralkyl carboxylic acid, a (C6-C12)alkaryl carboxylic acid, or combinations thereof.
32. The wet wipe of embodiment 31 wherein the soluble organic acid is an alpha-hydroxy acid.
33. The wet wipe of embodiment 31 wherein the soluble salt of an organic acid comprises at least a first and second acid wherein the first acid is added in its protonated form and the second acid is distinct from the first and is added as the soluble salt.
34. The wet wipe of any one of embodiments 21 through 33 wherein the surfactant comprises a sulfonate, a sulfate, a phosphonate, a phosphate, a sultaine, or mixtures thereof.
35. The wet wipe of any one of embodiments 21 through 34 wherein the composition further comprises a nonionic surfactant.
36. The wet wipe of any one of embodiments 21 through 35 which displays at least 3 to 6 log reduction in test bacteria in 30 seconds with 5% BSA for gram positive and gram negative when evaluated by the Antimicrobial Efficacy Test.
37. The wet wipe of any one of embodiments 21 through 36 which displays bacterial and viral inactivation according to the Disinfectant, Virucidal and Sanitizer Efficacy Test, and antimicrobial kill of both gram positive and gram negative bacteria according to the Antimicrobial Efficacy Test.
38. A method of killing or inactivating microorganisms, the method comprising contacting the microorganisms with the antimicrobial composition of embodiment 1 at a temperature of at least 4° C. for a time effective to kill or inactivate one or more microorganisms.
39. The method of embodiment 38 wherein the microorganisms comprise bacteria and the antimicrobial composition is used at a temperature of at least 4° C. for a time effective to kill one or more bacteria.
40. The method of embodiment 39 wherein the bacteria comprise Staphylococcus spp., Streptococcus spp., Escherichia spp., Enterococcus spp., Pseudamonas spp., or combinations thereof
41. The method of embodiment 40 wherein the bacteria comprise Staphylococcus aureus, Staphylococcus epidermidis, Escherichia coli, Pseudomonas aeruginosa, Streptococcus pyogenes, or combinations thereof.
42. The method of embodiment 38 wherein the microorganisms comprise one or more viruses and the antimicrobial composition is used under conditions effective to inactivate one or more viruses.
43. The method of embodiment 38 wherein the microorganisms comprise one or more fungi and the antimicrobial composition is used under conditions effective to kill one or more fungi.
44. A method of killing or inactivating microorganisms, the method comprising contacting the microorganisms with the wet wipe of embodiment 21 at a temperature of at least 4° C. for a time effective to kill or inactivate one or more microorganisms.
45. The method of embodiment 44 wherein the microorganisms comprise bacteria.
46. The method of embodiment 45 wherein the bacteria comprise Staphylococcus spp., Streptococcus spp., Escherichia spp., Enterococcus spp., Pseudamonas spp., or combinations thereof
47. The method of embodiment 46 wherein the bacteria comprise Staphylococcus aureus, Staphylococcus epidermidis, Escherichia coli, Pseudomonas aeruginosa, Streptococcus pyogenes, or combinations thereof.
48. The method of embodiment 44 wherein the microorganisms comprise one or more viruses and the wet wipe is used at a temperature of at least 4° C. for a time effective to inactivate one or more viruses.
49. The method of embodiment 44 wherein the microorganisms comprise one or more fungi and the antimicrobial composition is used at a temperature of at least 4° C. for a time effective to kill one or more fungi.

### EXAMPLES

### Materials

CAPMUL® 908P, Propylene glycol monocaprylate, is available from Abitec Corporation, Columbus, Ohio

SENSIVA® SC50, capryl glyceryl ether, is available from Schülke Inc, Fairfield, N.J.

Citric Acid (Anhydrous) is available from Ashland, Covington, Ky.

Sodium Benzoate is available is available from Emerald Performance Materials, LLC, Cuyahoga Falls, Ohio

Sorbic acid Potassium Salt is available from Sigma Aldrich, St. Louis, Mo.

PREVENTOL® ON Extra, Sodium ortho-phenylphenate (71.7%), is available from LANXESS Corporation, Pittsburgh, Pa.

Methylparaben is available from Clariant Corporation, Charlotte, N.C.

Propylparaben is available from Clariant Corporation, Charlotte, N.C.

NAXOLATE® AS-LG-85, Sodium Lauryl Sulfate, is available from Nease Corporation, Blue Ash, Ohio.

Sodium Lauryl Ether Sulfate is available Stepan Company, Northfield, Ill.

ARLASILK™ CDM, Sodium Coco PG-dimonium Chloride Phosphate, is available from Croda Inc., Edison. N.J.

GLUCOPON™ 215 UP, Caprylyl/Decyl Glucoside, is available from Cognis Corporation (BASF), Cincinnati, Ohio

GLUCOPON™ 420 UP, Caprylyl/Myristyl Glucoside, is available from Cognis Corporation (BASF), Cincinnati, Ohio

Propylene glycol is available from Dow Chemical Company, Midland, Mich. DOWANOL™ DPM,

Dipropylene glycol methyl ether, is available from Dow Chemical Company, Midland, Mich.

VERSENE™ NA, Disodium EDTA, is available from Dow Chemical Company, Midland, Mich.

Essential Oil, fragrance, is available from Symrise, Teterboro, N.J.

Sodium Hydroxide (20%), is available from Sigma Aldrich, St. Louis, Mo.

### Substrates

Wipe A: Cellulose based nonwoven (basis weight 48.5 grams/meter²), product code WL 102010, available from Suominen Corporation, Windsor Locks, Conn.

Wipe B: 70% Cellulose/30% Polypropylene nonwoven, (basis weight 40 grams/meter²), product code WL 180240, available from Suominen Corporation, Windsor Locks, Conn.

Wipe C: 70/30 Polyester/Rayon spunlace nonwoven (basis weight 45 grams/meter²), available from Jacob Holm Industries, Candler, N.C.

Wipe D: Coated abrasive spunlace nonwoven wipe (basis weight 55 grams/meter²), product code Spunlace 13P55V40P6OGDPF, available from N.R. Spuntech Industries Ltd., Roxboro, N.C.

### Test Methods

### Light Transmission

Percent transmission data (% T) was obtained with the use of a PerkinElmer® LAMBDA™ 1050 UV/Vis Spectrophotometer (available from PerkinElmer, Waltham, Mass.). Samples were measured in a 0.5 centimeter (cm) cell with an air reference using the standard LAMBDA™ 1050 dual-beam compartment. The baseline was collected using a quartz slide and an air reference. Spectra were measured in triplicate with standard deviations of less than 0.25% T. Data collection interval: 1 nm. Collection mode: Absorbance (Converted to % Transmission after acquisition). Collection range: 350-700 nanometers (nm).

### Gloss Reduction/Haze

Gloss readings were measured using a BYK Gardner Micro-TRI-gloss® gloss-meter, manufactured by BYK-Gardner, catalog number is 4446. The gloss-meter was calibrated and the angle geometry set to a 20° angle. A 0.55 cm thick black glass panel (60.5 cm length×21.5 cm width) was used as the test surface. The test surface was thoroughly cleaned and dried with a glass cleaner (such as WINDEX™). To obtain an initial gloss reading, the gloss of the clean test surface was measured at four locations along the length of the test surface (at approximately 14 cm, 21 cm, 26 cm, and 31 cm) and the readings averaged) initial gloss). Three pieces of the antimicrobial wet wipe to be tested (7 inches (in)×8 in) were cut and folded in half (3.5 in ×4 in). The wipe test sample was then attached to a test fixture (17 cm wide clip board attached to a flex-glass backing) such that the length of the wipe (4 in) was perpendicular to the direction of travel (wiping). A 500 gram load plate was placed onto the test sample. The wipe sample was then passed once over the clean test surface at a rate of 23 cm/5 seconds (sec) and the surface was allowed to dry at 23° C. and 50% relative humidity (RH). Gloss readings of the wiped surface were then measured and recorded at each of the same four locations that were used to obtain the initial gloss reading of the test surface control and the readings averaged (final gloss). Initial gloss readings were measured prior to testing with each of the three wipe samples. The percent gloss reduction for the wiped surface (average of 36 readings) versus the test surface control (average of 12 readings) was calculated:

% Gloss reduction=100×[(avg initial gloss−avg final gloss)/avg initial gloss]

### Antimicrobial Efficacy

An in vitro, time-kill assay based on ASTM E2315-03 (“Standard Guide for Assessment of Antimicrobial Activity Using a Time-Kill Procedure”) was used to determine the effectiveness of the antimicrobial compositions (either formed compositions or liquids expressed from loaded wipes). The activity of the compositions was tested toward several different microorganisms. Microorganisms were grown on suitable agar (Tryptic Soy Agar) and inoculums were prepared in Butterfield's phosphate buffer with addition of 5% Bovine Serum Albumin (BSA) with a cell density of approximately 1.0×10⁸ CFU/mL. Each test sample (3 ml sample size) was combined with a 30 μl inoculum and a vortex mixer was used to achieve good mixing. After a determined time point (30 seconds), the sample was neutralized to stop antimicrobial activity. Dey-Engley broth was used as the neutralizing solution. Neutralized samples were further serial diluted and plated onto 3M Aerobic PETRIFILM™. After incubation the number of surviving microorganisms expressed was counted in CFU (colony forming units). For instances where the antimicrobial activity was below the limit of detection, the whole amount of neutralized sample was plated or the neutralized sample was filtered through a cellulose membrane. Following incubation, the plates or the membrane were evaluated for microbial growth. A test control was prepared by combining Butterfield's phosphate buffer with inoculums and data was obtained in the same manner as for a test sample.

### Disinfectant, Virucidal and Sanitizer Efficacy

Some examples were tested for broad spectrum disinfectant, virucidal, and sanitizer disinfectant efficacy at 10 minutes exposure time. The disinfectant and virucidal tests were performed by following the EPA Guideline: OCSPP 810.2200. The sanitizer tests were performed by following the EPA Guideline: OCSPP 810.2300. For the antimicrobial compositions tested, the wipe substrate was saturated with the antimicrobial composition. The activity of the loaded wipe was then tested toward several different microorganisms with 5% fetal bovine serum organic soil load used in the testing.

### Preparation of Antimicrobial Compositions

In a typical procedure, the aqueous antimicrobial composition was prepared by completely dissolving the organic acid and/or organic acid salt in deionized water in a glass beaker and stirring using a stir bar at a ambient temperature. The surfactant was then added and stirring continued until it was completely dissolved. The preservative (if included) was then added. An antimicrobial lipid, co-surfactant, and fragrance (if included) was then added into the mixture and mixing was continued until a completely clear composition was obtained. If necessary, the resulting clear composition was then adjusted to the desired pH with a 20% sodium hydroxide solution.

### Examples 1-12

The antimicrobial compositions shown in Tables 1 and 2 for Examples 1-12 were prepared as described above. Examples 1-8 were tested for antimicrobial efficacy according to the above method. Results are provided in Table 1. Examples 9-12 were tested for percent transmission according to the above method. Results are provided in Table 2.

TABLE 1

| Component (wt %) | Ex 1 | Ex 2 | Ex 3 | Ex 4 | Ex 5 | Ex 6 | Ex 7 | Ex 8 |
|---|---|---|---|---|---|---|---|---|
| CAPMUL ® 908P | 0.40 | 0.40 | 0.40 | 0.40 | 0.40 | 0.40 | 0.40 | 0.40 |
| Citric Acid | 0.01 | 0.20 | 0.04 | 0.04 | 0.20 | 0.20 | 0.20 | 0.20 |
| Sodium Benzoate | — | 0.60 | — | — | 0.60 | 0.60 | 0.60 | 0.60 |
| NAXOLATE ® AS-LG-85 | 0.80 | 0.80 | 0.40 | 0.40 | 0.40 | 0.40 | 0.60 | 0.60 |
| GLUCOPON ™ 215 UP | — | — | — | 0.40 | — | 0.40 | — | — |
| GLUCOPON ™ 420 UP | — | — | 0.40 | — | 0.40 | — | — | — |
| DOWANOL ™DPM | — | — | — | — | — | — | — | 0.40 |
| PREVENTOL ® ON Extra | — | — | — | — | — | — | 0.05 | — |
| Water | 98.79 | 98.00 | 98.76 | 98.76 | 98.00 | 98.00 | 98.15 | 97.80 |
| pH | 4.28 | 4.74 | 3.93 | 3.88 | 4.74 | 4.76 | 4.77 | 4.62 |
| Visual appearance | clear | Clear | clear | clear | clear | clear | clear | clear |
| Staphylococcus Aureus | | | | | | | | |
| ATCC 6538 (gram-positive) | | | | | | | | |
| Log reduction (log₁₀) | 4.03 | 4.55 | 4.55 | 4.59 | 3.83 | 4.02 | 4.59 | 4.59 |
| Salmonella Choleraesuis | | | | | | | | |
| ATCC 10708 (gram-negative) | | | | | | | | |
| Log reduction (log₁₀) | 4.66 | 4.90 | 4.90 | 4.91 | 4.91 | 4.91 | 4.91 | 4.91 |

TABLE 2

| Component (wt %) | Ex 9 | Ex 10 | Ex 11 | Ex 12 |
|---|---|---|---|---|
| CAPMUL ® 908P | 0.30 | 0.35 | 0.55 | 1.00 |
| Citric Acid | 0.33 | 0.24 | 0.25 | 0.32 |
| Sodium Benzoate | 0.65 | 0.65 | 0.65 | 0.65 |
| NAXOLATE ® AS-LG-85 | 0.40 | 0.60 | 0.94 | 2.00 |
| Propylene glycol | 0.75 | 0.70 | 0.30 | 0.75 |
| PREVENTOL ® ON Extra | 0.04 | 0.05 | 0.05 | — |
| Essential oil | 0.02 | 0.03 | — | — |
| Water | 97.51 | 97.38 | 97.26 | 95.28 |
| Visual appearance | Clear | clear | clear | clear |
| % T at 550 nm wavelength | 99.4 | 98.8 | 99.4 | 99.7 |

### Examples 13-26

The antimicrobial compositions shown in Table 3 for Examples 13-26 were prepared as described above. Antimicrobial wipes were prepared with each formulation by impregnating a nonwoven substrate (Wipe B) with between 300 weight % and 600 weight % of the antimicrobial composition (based on the dry weight of the substrate) so that the substrate was saturated with the antimicrobial composition. The liquid was then expressed from the wipes after sitting at room temperature from 1-3 days. The expressed liquids were tested for antimicrobial efficacy at a 30 second exposure time using the method described above. Results are provided in Table 3.

Antimicrobial wipes were also prepared for the formulations of Examples 13-22 by impregnating a nonwoven substrate (Wipe C) with between 300 weight % and 600 weight % of each antimicrobial composition (based on the dry weight of the substrate) so that the substrate was saturated with the antimicrobial composition. The liquid was then expressed from the wipes after sitting at room temperature from 1-3 days. The wipes were then used to test for gloss reduction as described above. Results are provided in Table 3.

TABLE 3¶

| Component (wt. | | | | | | | | |
|---|---|---|---|---|---|---|---|---|
| %) [symbol] | Ex. 13 [symbol] | Ex. 14 [symbol] | Ex. 15 [symbol] | Ex. 16 [symbol] | Ex. 17 [symbol] | Ex. 18 [symbol] | Ex. 19 [symbol] | Ex. 20 [symbol] |
| CAPMUL ® 908P [symbol] | — [symbol] | 0.25 [symbol] | 0.20 [symbol] | 0.25 [symbol] | 0.20 [symbol] | 0.15 [symbol] | 0.25 [symbol] | 0.20 [symbol] |
| SENSIVA ® SC5D [symbol] | 0.40 [symbol] | | | | | | | |
| Citric Acid [symbol] | 0.25 [symbol] | 0.30 [symbol] | 0.39 [symbol] | 0.30 [symbol] | 0.13 [symbol] | 0.35 [symbol] | 0.18 [symbol] | 0.39 [symbol] |
| Sorbic acid | — [symbol] | 0.50 [symbol] | 0.21 [symbol] | 0.20 [symbol] | 0.07 [symbol] | 0.15 [symbol] | 0.12 [symbol] | — [symbol] |
| potassium salt [symbol] | | | | | | | | |
| Sodium Benzoate [symbol] | 0.65 [symbol] | — [symbol] | — [symbol] | — [symbol] | — [symbol] | — | — [symbol] | 0.10 [symbol] |
| NAXOLATE ® AS- | 0.80 [symbol] | 0.50 [symbol] | 0.40 [symbol] | 0.50 [symbol] | 0.40 [symbol] | 0.30 [symbol] | 0.50 [symbol] | 0.40 [symbol] |
| LG-85 [symbol] | | | | | | | | |
| Sodium Lauryl | — [symbol] | — [symbol] | — [symbol] | — [symbol] | — [symbol] | — [symbol] | — [symbol] | — [symbol] |
| Ethar Sulfate [symbol] | | | | | | | | |
| ARLASIK CDM [symbol] | — [symbol] | — [symbol] | — [symbol] | — [symbol] | — [symbol] | — [symbol] | — [symbol] | — [symbol] |
| Propylene glycol [symbol] | — [symbol] | 1.00 [symbol] | 1.00 [symbol] | 1.00 | 1.00 [symbol] | 1.00 [symbol] | 1.00 [symbol] | 1.00 [symbol] |
| Methylparaben [symbol] | — [symbol] | 0.20 [symbol] | — [symbol] | — [symbol] [symbol] | — [symbol] | — [symbol] | — [symbol] | — [symbol] |
| Propylparaben [symbol] | — [symbol] | — [symbol] | — [symbol] | — [symbol] | — [symbol] | — [symbol] | — [symbol] | — [symbol] |
| PREVENTOL ® | 0.05 [symbol] | — [symbol] | 0.13 [symbol] | 0.15 [symbol] | 0.13 [symbol] | 0.10 [symbol] | 0.10 [symbol] | 0.13 [symbol] |
| ON Extra [symbol] | | | | | | | | |
| Disodium EDTA [symbol] | — [symbol] | — [symbol] | — [symbol] | — [symbol] | — [symbol] | — [symbol] | — [symbol] | — [symbol] |
| Essential oil [symbol] | — [symbol] | 0.02 [symbol] | 0.02 [symbol] | 0.02 [symbol] | 0.02 [symbol] | 0.02 [symbol] | 0.02 [symbol] | 0.02 [symbol] |
| Sodium hydroxide | — [symbol] | 0.50 [symbol] | 0.33 [symbol] | 0.30 [symbol] | 0.30 [symbol] | 0.30 [symbol] | 0.30 [symbol] | 0.40 [symbol] |
| (20% aqueous) [symbol] | | | | | | | | |
| Water [symbol] | 97.85 [symbol] | 96.73 [symbol] | 97.32 [symbol] | 97.28 [symbol] | 97.75 [symbol] | 97.63 [symbol] | 97.53 [symbol] | 97.36 [symbol] |
| pH [symbol] | 4.5 [symbol] | 5.0 [symbol] | 4.5 [symbol] | 4.5 [symbol] | 4.6 [symbol] | 4.3 [symbol] | 4.8 [symbol] | 4.3 [symbol] |
| Visual appearance [symbol] | Clear [symbol] | Clear [symbol] | Clear [symbol] | Clear [symbol] | Clear [symbol] | Clear [symbol] | Clear [symbol] | Clear [symbol] |
| % Gloss reduction [symbol] | — [symbol] | 3.60 [symbol] | 0.72 [symbol] | 1.39 [symbol] | 0.81 [symbol] | 0.92 [symbol] | 2.05 [symbol] | 1.47 [symbol] |
| Staphylococcus | | | | | | | | |
| Aureus ATCC- | | | | | | | | |
| 6538 (gram- | | | | | | | | |
| positive) [symbol] | | | | | | | | |
| Logreduction- | — [symbol] | 3.63 [symbol] | 4.65 [symbol] | 3.55 [symbol] | 3.61 [symbol] | 4.42 [symbol] | 2.90 [symbol] | 4.65 [symbol] |
| (log₁₀) [symbol] | | | | | | | | |
| Salmonella- | [symbol] | | | | | | | |
| Tryphinium- | | | | | | | | |
| ATCC-14028- | | | | | | | | |
| (gram-negative) [symbol] | | | | | | | | |
| Logreduction- | — [symbol] | — [symbol] | 4.61 [symbol] | 4.61 [symbol] | 4.61 [symbol] | 4.61 [symbol] | 4.46 [symbol] | 4.61 [symbol] |
| (log₁₀) [symbol] | | | | | | | | |

| Component (wt. | | | | | | | |
|---|---|---|---|---|---|---|---|
| %) [symbol] | Ex. 21 [symbol] | Ex. 22 [symbol] | Ex. 23 [symbol] | Ex. 24 [symbol] | Ex. 25 [symbol] | Ex. 26 [symbol] | [symbol] |
| CAPMUL ® 908P [symbol] | 0.20 [symbol] | 0.20 [symbol] | 0.20 [symbol] | 0.20 [symbol] | 0.20 [symbol] | 0.24 [symbol] | [symbol] |
| SENSIVA ® SC5D [symbol] | [symbol] | [symbol] | [symbol] | [symbol] | [symbol] | [symbol] | [symbol] |
| Citric Acid [symbol] | 0.39 [symbol] | 0.39 [symbol] | 0.39 [symbol] | 0.39 [symbol] | 1.00 [symbol] | 0.30 [symbol] | [symbol] |
| Sorbic acid | — [symbol] | — [symbol] | 0.21 [symbol] | 0.21 [symbol] | 0.50 [symbol] | — [symbol] | [symbol] |
| potassium salt [symbol] | | | | | | | |
| Sodium Benzoate [symbol] | 0.10 [symbol] | 0.50 [symbol] | — [symbol] | — [symbol] | 0.20 [symbol] | 0.50 [symbol] | [symbol] |
| NAXOLATE ® AS- | 0.40 [symbol] | 0.40 [symbol] | — [symbol] | 0.40 [symbol] | 0.40v | 0.51 [symbol] | [symbol] |
| LG-85 [symbol] | | | | | | | |
| Sodium Lauryl | — [symbol] | — [symbol] | 0.40 [symbol] | — [symbol] | — [symbol] | — [symbol] | [symbol] |
| Ethar Sulfate [symbol] | | | | | | | |
| ARLASIK CDM [symbol] | — [symbol] | — [symbol] | — [symbol] | — [symbol] | — [symbol] | 0.20 [symbol] | [symbol] |
| Propylene glycol [symbol] | 1.00 [symbol] | 1.00 [symbol] | 1.00 [symbol] | 1.00 [symbol] | 1.00 [symbol] | 0.79 [symbol] | [symbol] |
| Methylparaben [symbol] | — [symbol] | — [symbol] | — [symbol] | — [symbol] | 0.20 [symbol] | — [symbol] | [symbol] |
| Propylparaben [symbol] | — [symbol] | — [symbol] | — [symbol] | — [symbol] | 0.10 [symbol] | — [symbol] | [symbol] |
| PREVENTOL ® | 0.05 [symbol] | 0.13 [symbol] | 0.13 [symbol] | 0.13 [symbol] | — [symbol] | — [symbol] | [symbol] |
| ON Extra [symbol] | | | | | | | |
| Disodium EDTA [symbol] | 0.10 [symbol] | — [symbol] | — [symbol] | — [symbol] | — [symbol] | — [symbol] | [symbol] |
| Essential oil [symbol] | 0.02 [symbol] | 0.02 [symbol] | 0.02 [symbol] | 0.02 [symbol] | 0.02 [symbol] | 0.02 [symbol] | [symbol] |
| Sodium hydroxide | 0.50 [symbol] | 0.10 [symbol] | 0.33 [symbol] | 0.33 [symbol] | 0.50 [symbol] | 0.36 [symbol] | [symbol] |
| (20% aqueous) [symbol] | | | | | | | |
| Water [symbol] | 97.24 [symbol] | 97.26 [symbol] | 97.32 [symbol] | 97.32 [symbol] | 95.88 [symbol] | 97.08 [symbol] | [symbol] |
| pH [symbol] | 4.2 [symbol] | 4.1 [symbol] | 4.5 [symbol] | 4.5 [symbol] | 4.8 [symbol] | 4.5 [symbol] | [symbol] |
| Visual appearance [symbol] | Clear [symbol] | Clear [symbol] | Clear [symbol] | Clear [symbol] | Clear [symbol] | Clear [symbol] | [symbol] |
| % Gloss reduction [symbol] | 1.93 [symbol] | 1.28 [symbol] | — [symbol] | — [symbol] | — [symbol] | — [symbol] | [symbol] |
| Staphylococcus | [symbol] | | | | | | |
| Aureus ATCC- | | | | | | | |
| 6538 (gram- | | | | | | | |
| positive) [symbol] | | | | | | | |
| Logreduction- | 4.65 [symbol] | 4.65 [symbol] | 1.59 [symbol] | 4.65 [symbol] | 2.80 [symbol] | 3.68 [symbol] | [symbol] |
| (log₁₀) [symbol] | | | | | | | |
| Salmonella- | [symbol] | | | | | | |
| Tryphinium- | | | | | | | |
| ATCC-14028- | | | | | | | |
| (gram-negative) [symbol] | | | | | | | |
| Logreduction- | 4.61 [symbol] | 4.61 [symbol] | 4.61 [symbol] | 4.37 [symbol] | 0.83 [symbol] | 0.48 [symbol] | [symbol] |
| (log₁₀) [symbol] | | | | | | | |

¶

The Example 22 formulation was also tested for broad spectrum disinfectant and virucidal efficacy at a 10 minute exposure time as described above. A nonwoven substrate (Wipe C: 70% Polyester/30% Rayon) with between 300 weight % and 600 weight % of the antimicrobial composition (based on the dry weight of the substrate) so that the substrate was saturated with the antimicrobial composition. The liquid was then expressed from the wipe after sitting at room temperature from 1-3 days. The expressed liquid was tested for disinfectant and virucidal efficacy at a 10 minute exposure time using the method described above. Results are provided in Tables 4 and 5.

TABLE 4
Disinfectant Efficacy (EPA Guideline: OCSPP 810.2200)

| | Staphylococcus | Salmonella | |
|---|---|---|---|
| | Aureus | Typhinurium | E. Coli |
| Wipe Example | ATCC 6538 | ATCC 14028 | ATCC 8357 |
| Example 10 with | 0/60 Carriers | 0/60 Carriers | 0/10 Carriers |
| Polyester/rayon substrate | (No Growth) | (No Growth) | (No Growth) |

TABLE 5
Virucidal Efficacy (EPA Guideline: OCSPP 810.2200)

| Wipe Example | Rhinovirus Type 37 | Influenza Type A |
|---|---|---|
| Example 10 with | 6.00 log₁₀ | 4.00 log₁₀ |
| Polyester/rayon substrate | reduction | reduction |

### Examples 27 and 28

The antimicrobial compositions shown in Table 6 for Examples 27 and 28 were prepared as described above. Antimicrobial wipes were prepared with each formulation by impregnating nonwoven substrates (Wipe A, Wipe B, and Wipe D) with between 300 weight % and 600 weight % of the antimicrobial composition (based on the dry weight of the substrate) so that the substrates were saturated with the antimicrobial compositions. The liquid was then expressed from the wipes after sitting at room temperature from 1-3 days. The expressed liquids were tested for disinfectant, virucidal and sanitizer efficacy using the method described above. Results are provided in Table 7.

TABLE 6

| Component (wt %) | Ex 27 | Ex 28 |
|---|---|---|
| CAPMUL ® 908P | 0.36 | 0.38 |
| Citric Acid | 0.25 | 0.25 |
| Sodium Benzoate | 0.65 | 0.65 |
| NAXOLATE ® AS-LG-85 | 0.61 | 0.65 |
| Propylene glycol | 0.50 | 0.30 |
| PREVENTOL ® ON Extra | 0.05 | 0.05 |
| Essential oil | 0.03 | 0.03 |
| Water | 97.55 | 97.69 |
| Visual appearance | clear | clear |

TABLE 7

| Wipe Example | | |
|---|---|---|
| Ex27 with | Ex27 with | Ex28 with |
| Wipe A | Wipe B | Wipe D |

Disinfectant Efficacy (OCSPP 810.2200) - Bacterial
Growth/Carrier in 10 minutes exposure time

| | | | |
|---|---|---|---|
| Staphylococcus | 0/60 Carriers | 0/10 Carriers | 0/10 Carriers |
| aureus ATCC 6538 | (No growth) | (No growth) | (No growth) |
| Salmonella | 0/60 Carriers | 0/10 Carriers | 0/10 Carriers |
| Enterica ATCC 10708 | (No growth) | (No growth) | (No growth) |
| Escherichia coli | 0/10 Carriers | 0/10 Carriers | 0/10 Carriers |
| ATCC 11229 | (No growth) | (No growth) | (No growth) |

Virucidal Disinfectant Efficacy (OCSPP 810.2200) - Log₁₀
Reduction in 10 minutes exposure time

| | | | |
|---|---|---|---|
| Influenza Type A | 5.00 | 5.00 | 5.00 |
| Rhinovirus Type 38 | 4.00 | 4.00 | 4.00 |
| Human Corona Virus | 3.00 | 3.00 | 3.00 |

Sanitizer Efficacy (OCSPP 810.2300) - %
reduction in 30 seconds exposure time

| | | | |
|---|---|---|---|
| Staphylococcus | >99.9% | >99.9% | >99.9% |
| aureus ATCC 6538 | | | |
| Enterobacter | >99.9% | >99.9% | >99.9% |
| aerogenes ATCC 13048 | | | |
| Escherichia coli | >99.9% | >99.9% | >99.9% |
| ATCC 11229 | | | |
| Salmonella | >99.9% | >99.9% | >99.9% |
| Enterica ATCC 10708 | | | |

Note:
>99.9% means a log₁₀ reduction >3

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follow

1. An antimicrobial composition comprising:
0.1 wt % to 1.0 wt %, based on the total weight of the composition, of an antimicrobial lipid; wherein the antimicrobial lipid comprises a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, or combinations thereof, wherein the alkoxylated derivative has less than 5 moles of alkoxide per mole of polyhydric alcohol, (C5-C12)1,2-saturated alkanediol, and (C12-C18)1,2-unsaturated alkanediol; with the proviso that for polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof;
0.1 wt % to 2.0 wt %, based on the total weight of the composition, of an anionic and/or zwitterionic surfactant;
0.03 wt % to 2.0 wt %, based on the total weight of the composition, of an enhancer comprising a soluble organic acid and/or a soluble organic acid salt; and
at least 85 wt % water, based on the total weight of the composition;
wherein the antimicrobial lipid and the enhancer are present in a ratio of 10:1 to 1:40;
wherein the surfactant and antimicrobial lipid are present in a ratio of greater than 0.5:1;
wherein the pH of the composition is 3 to 6, and is no more than 1 unit higher than the pKa of the monofunctional organic acid present with the highest pKa, or no more than 1 unit higher than the highest pKa value less than 5 for polyfunctional organic acids present;
wherein the composition is in a ready-to-use form that is physically stable; and wherein at least one of the following is true:
the antimicrobial lipid is liquid when in neat form at 23° C.; or
the composition has an optical transmission at 550 nm with a path length of 0.5 cm of at least 80% when measured according to the Light Transmission Test.

2. The composition of claim 1 which demonstrates antimicrobial activity 3 to 6 log reduction in 30 second antimicrobial efficacy test with 5% BSA for gram positive and gram negative.

3. The composition of claim 1 wherein the enhancer is present in an amount of 0.03 wt % to 1.5 wt %, based on the total weight of the composition.

4-5. (canceled)

6. The composition of claim 1 further comprising a hydrophilic co-solvent.

7. The composition of claim 1 wherein the antimicrobial lipid comprises a monoester of a polyhydric alcohol, a monoether of a polyhydric alcohol, or an alkoxylated derivative thereof, or combinations thereof.

8. The composition of claim 1 wherein the antimicrobial lipid comprises propylene glycol monolaurate, propylene glycol monocaprate, propylene glycol monocaprylate, or combinations thereof.

9. The composition of claim 1 wherein the soluble organic acid is an alpha-hydroxy acid, a beta-hydroxy acid, a (C1-C4)alkyl carboxylic acid, a (C6-C12)aryl carboxylic acid, a (C6-C12)aralkyl carboxylic acid, a (C6-C12)alkaryl carboxylic acid, or combinations thereof.

10. The composition of claim 1 wherein the composition comprises at least a first and second acid wherein the first acid is added in its protonated form and the second acid is distinct from the first and is added as its soluble salt.

11. The composition of claim 1 wherein the surfactant comprises a sulfonate, a sulfate, a phosphonate, a phosphate, a sultaine, or mixtures thereof.

12. The composition of claim 1 further comprising a nonionic surfactant.

13. The composition of claim 1 which displays at least 3 log reduction in test bacteria in 30 seconds with 5% BSA when evaluated by the Antimicrobial Efficacy Test.

14. The composition of claim 1 which displays bacterial and viral inactivation according to the Disinfectant, Virucidal and Sanitizer Efficacy Test, and antimicrobial kill of both gram positive and gram negative bacteria according to the Antimicrobial Efficacy Test.

15. A wet wipe comprising a substrate and a composition impregnated in the substrate, the composition comprising:
0.1 wt % to 1.0 wt %, based on the total weight of the composition, of an antimicrobial lipid;
wherein the antimicrobial lipid comprises a (C8-C12)saturated fatty acid ester of a polyhydric alcohol, a (C12-C22)unsaturated fatty acid ester of a polyhydric alcohol, a (C8-C12)saturated fatty ether of a polyhydric alcohol, a (C12-C22)unsaturated fatty ether of a polyhydric alcohol, an alkoxylated derivative thereof, or combinations thereof, wherein the alkoxylated derivative has less than 5 moles of alkoxide per mole of polyhydric alcohol, (C5-C12)1,2-saturated alkanediol, and (C12-C18)1,2-unsaturated alkanediol; with the proviso that for polyhydric alcohols other than sucrose, the esters comprise at least 80 wt % monoesters and the ethers comprise at least 80 wt % monoethers, and for sucrose the esters comprise at least 80 wt % monoesters, diesters, or combinations thereof;
0.1 wt % to 2.0 wt %, based on the total weight of the composition, of an anionic and/or zwitterionic surfactant;
0.03 wt % to 2.0 wt %, based on the total weight of the composition, of an enhancer comprising a soluble organic acid and a soluble organic acid salt; and
at least 85 wt % water, based on the total weight of the composition;
wherein the antimicrobial lipid and the enhancer are present in a ratio of 10:1 to 1:40;
wherein the surfactant and antimicrobial lipid are present in a ratio of greater than 0.5:1;
wherein the pH of the composition is 3 to 6, and is no more than 1 unit higher than the pKa of the monofunctional organic acid present with the highest pKa, or no more than 1 unit higher than the highest pKa value less than 5 for polyfunctional organic acids present;
wherein the composition is in a ready-to-use form that is physically stable; and wherein at least one of the following is true:
the antimicrobial lipid is liquid when in neat form at 23° C.; or
the composition has an optical transmission at 550 nm with a path length of 0.5 cm of at least 80% when measured according to the Light Transmission Test.

16. The wet wipe of claim 15 that exhibits a percent gloss reduction after wiping when compared to a clean test surface of less than 10%, when tested by the Gloss Reduction/Haze Test.

17-18. (canceled)

19. The wet wipe of claim 15 wherein the soluble organic acid is an alpha-hydroxy acid, a beta-hydroxy acid, a (C1-C4)alkyl carboxylic acid, a (C6-C12)aryl carboxylic acid, a (C6-C12)aralkyl carboxylic acid, a (C6-C12)alkaryl carboxylic acid, or combinations thereof.

20. The wet wipe of claim 15 wherein the surfactant comprises a sulfonate, a sulfate, a phosphonate, a phosphate, a sultaine, or mixtures thereof.

21. (canceled)

22. The wet wipe of claim 15 which displays at least 3 to 6 log reduction in test bacteria in 30 seconds with 5% BSA for gram positive and gram negative when evaluated by the Antimicrobial Efficacy Test.

23. The wet wipe of claim 15 which displays bacterial and viral inactivation according to the Disinfectant, Virucidal and Sanitizer Efficacy Test, and antimicrobial kill of both gram positive and gram negative bacteria according to the Antimicrobial Efficacy Test.

24. A method of killing or inactivating microorganisms, the method comprising contacting the microorganisms with the antimicrobial composition of claim 1 at a temperature of at least 4° C. for a time effective to kill or inactivate one or more microorganisms.

25. A method of killing or inactivating microorganisms, the method comprising contacting the microorganisms with the wet wipe of claim 15 at a temperature of at least 4° C. for a time effective to kill or inactivate one or more microorganisms.
